(19) United States
(12) Patent Application Publication
(10) Pub. No.: US 2019/0073715 A1
(43) Pub. Date: Mar. 7, 2019

(54) Method and System for Summarizing a Moving Average Strategy

(71) Applicant: Randolph C. Snook, Bernardsville, NJ (US)

(72) Inventor: Randolph C. Snook, Bernardsville, NJ (US)

(21) Appl. No.: 15/877,968

(22) Filed: Jan. 23, 2018

Related U.S. Application Data
(60) Provisional application No. 62/555,386, filed on Sep. 7, 2017.

(51) Int. Cl. G06Q 40/04; G06Q 40/06; G06Q 10/06

(52) U.S. Cl. CPC G06Q 40/04; G06Q 10/0637; G06Q 40/06

(57) ABSTRACT

Strategy relies on extracting signals from at least two major indices, S&P 500 and the VIX (S&P 500 implied volatility). The main idea of the strategy is to extract a signal to sell equity and a signal to buy back equity. Let Eₜ and Vₜ be the prices of the S&P 500 and the VIX index at day t, respectively. Moreover, let Rₜ^{E} and Rₜ^{V} denote the change rate of the S&P 500 and the VIX indices, respectively. Sensitivity, or volatility, is determined based on cumulative return statistics over a period of time.

### CROSS-REFERENCE TO RELATED APPLICATIONS

This application claims priority to U.S. Provisional 62/555,386, filed Sep. 7, 2017, which is hereby incorporated by reference.

### FIELD OF THE INVENTION

The present invention relates to extracting signals from two major indices, and, more particularly, extracting signals from the S&P 500 and the VIX (S&P 500 implied volatility).

### BRIEF SUMMARY OF THE INVENTION

A method and system for extracting signals from at least two major indices to develop a strategy, the method, with at least one computing device, comprising: extracting at least one signal, performing at least one action in response to the extracted at least one signal, and transmitting at least one notification comprising the at least one signal. The method and system further comprises determining at least one optimal combination to calculate a sensitivity of the strategy, and graphically representing a cumulative return over one or more years with respect to the at least one optimal combination. Sensitivity is determined based on heterogeneity across the one or more years yielding high performance with lower volatility. The at least two major indices comprise the S&P 500 and VIX. The at least one signal may be either a buy signal or a sell signal.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is an optimal combination graph in accordance with the disclosed invention;

FIG. 2 is a combination using cumulative return as performance graph in accordance with the disclosed invention;

FIG. 3 is a performance graph in accordance with the disclosed invention; and

FIGS. 4a-4d are cumulative return graphs in accordance with the disclosed invention;

FIGS. 5a-5n are strategy performance graphs in accordance with embodiments of the disclosed invention.

FIG. 6a-6x are cumulative return graphs in accordance with embodiments of the disclosed invention; and

FIG. 7 is an exemplary simplified functional block diagram in accordance with at least one embodiment of the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

### 1 Strategy Description

The disclosed strategy relies on extracting signals from at least two major indices, the S&P 500 and the VIX (S&P 500 implied volatility), for example. The main idea of the strategy is to extract a signal to sell equity and a signal to buy back equity. Let Eₜ and Vₜ be the prices of the S&P 500 and the VIX index at day t, respectively. Moreover, let Rₜ^{E} and Rₜ^{V} denote the change rate of the S&P 500 and the VIX indices, respectively. Put formally

$$\begin{matrix}{R}_{t}^{E} = \frac{{E}_{t} - {E}_{t - 1}}{{E}_{t - 1}} \\ and & ( 1 ) \\ {R}_{t}^{V} = \frac{{V}_{t} - {V}_{t - 1}}{{V}_{t - 1}} . & ( 2 )\end{matrix}$$

In this example, for the S&P 500, Rₜ^{E} resembles the rate of return on holding the index over 1 period (day). The same applies to the Rₜ^{V}. This is meaningful, especially when a trader can buy an ETN that mimics the VIX, e.g. VXX.

Finally, let Rₜ^{E}(k) and Rₜ^{V}(m) denote the moving averages (MAs) of Rₜ^{E} and Rₜ^{V} over k and m periods, correspondingly. We distinguish between k and m on purpose, as we shall describe below.

We consider the MAs of the change rate rather than the price for two main reasons. The first is the non-stationary of asset prices. Performing analysis on non-stationary can be unreliable as it results in spurious relationship. One example is the serial correlation of prices. Prices tend to be highly correlated whereas the return on prices are not. As a result, the change of the price serves as a more accurate signal that filters out spurious trends.

Second, due to non-stationary of prices, it is unclear what the equilibrium price is. Whereas, when one considers asset returns instead, daily returns deem to be stationary around a zero mean. Hence, it is more relevant to consider a MA with respect to a stationary target rather than non-stationary one. A positive MA of return indicates the time series has shifted from its equilibrium. Since the time series is stationary, it can be conjectured that the time series will exhibit some sort of reversal in the future. However, the same can be argued for prices, as they do not exhibit stationary. We discuss this detail in the following subsection.

### 1.1 Sell Signal

Holding equity by the end of day t, the strategy sells equity and buys bonds for the next day, t+1, if the following condition holds true:

{Rₜ^{E}>R̅ₜ^{E}(k)}∩{Rₜ^{V}>R̅ₜ^{V}(m)}. (3)

The sell signal returns 1 if the condition in (3) holds true at time t and 0 otherwise. Hence, when holding 100% equity at the end oft and the sell signal shows up, we sell the position and replace it with a bond position at t+1.

Note that the event in (3) is more sparse than the case of a reversal strategy, which sells equity when todays return is higher than its MA. Obviously, the sell signal requires two events to take place: return on equity is higher than its MA and the change in volatility rate is higher than its corresponding MA.

The extracted sell signal depends on two MAs with different lengths, k and m. We do not impose that both should be equal, i.e. k=m is not necessarily true. This adds more flexibility and degrees of freedom to determine these inputs. Eventually, the idea behind this is to find an optimal combination of (k*,m*) that yields highest performance.

### 1.2 Buy Signal

Holding bonds at t+1, we buy back equity at t+2, if the following event holds true

Rₜ₊₁^{E}<R̅ₜ₊₁^{E}(k) (3)

This condition implies that we buy back equity if it becomes cheap again. Clearly, the equity buy-back signal is less strict than the sell signal. Hence, after selling equity, the buy condition allows us to hold bonds for longer periods and results in a smaller number of trades.

### 2 Application

### 2.1 Data

To apply our strategy, we look daily at adjusted closing prices from Yahoo Finance dating back to Jan. 29, 1993 until Dec. 31, 2016. We rely on the S&P 500 and the VIX indices to extract the signals described in conditions 3 and 4. To materialize the strategy, we start with a 100% position in the SPY ETF and, depending on the signals, we trade between SPY and IEF. The introduction of IEF as an ETF began in late 2002. Hence, we use cash versus equity for the trading days prior to the inception of the IEF. The adjusted closing prices include dividend yield.

### 2.2 Benchmark

As our benchmark, we consider a passive portfolio that holds 60% in SPY and 40% in IEF.

### 2.3 Optimal Strategy

Our strategy depends on the choice of (k, m). To determine the optimal combination, we are interested in finding the parameters that outperform the benchmark with least volatility. To put formally, let Y denote the total years in the sample. Also, let Pᵢ^{s} and Pᵢ^{B} denote the performance of the strategy and benchmark, respectively, in a given year i. Standing at the end of year of y today with Y years of history, we choose (k, m) that maximizes the following statistic:

$$\begin{matrix}{Z}_{y} ( k , m ) = \frac{{\overline{P}}_{y}^{S} - {\overline{P}}_{y}^{B}}{\sqrt{\frac{1}{Y - 1} {\sum }_{i = y - Y + 1}^{y} {( {P}_{i}^{S} - {\overline{P}}_{y}^{S} )}^{2}}} & ( 4 ) \\ {\overline{P}}_{y}^{S} = \frac{{\sum }_{i = y - Y + 1}^{y} {P}_{i}^{S}}{Y} & ( 5 ) \\ {\overline{P}}_{y}^{B} = \frac{{\sum }_{i = y - Y + 1}^{y} {P}_{i}^{B}}{Y} & ( 6 )\end{matrix}$$

There are two forces affecting the level of the Z statistic from Equation (5). The first one relates to the average outperformance of the strategy over the benchmark. The second force punishes the choice of (k, m) that are associated with strategy's performance volatility over the Y years. Hence, the optimal combination (k, m) takes into account both aspects.

As for the performance measure, i.e. Pᵢ^{s} and Pᵢ^{B}, we consider either the Sharpe-ratio (SR) or the cumulative return in a single year. Our analysis proceeds in two different parts. The first is a pure in-sample analysis in which we find the optimal strategy starting from January 2003 until December 2016. The second part performs a rolling window analysis as a robustness to check whether our strategy stands the test of time.

### 2.3.1 In-Sample

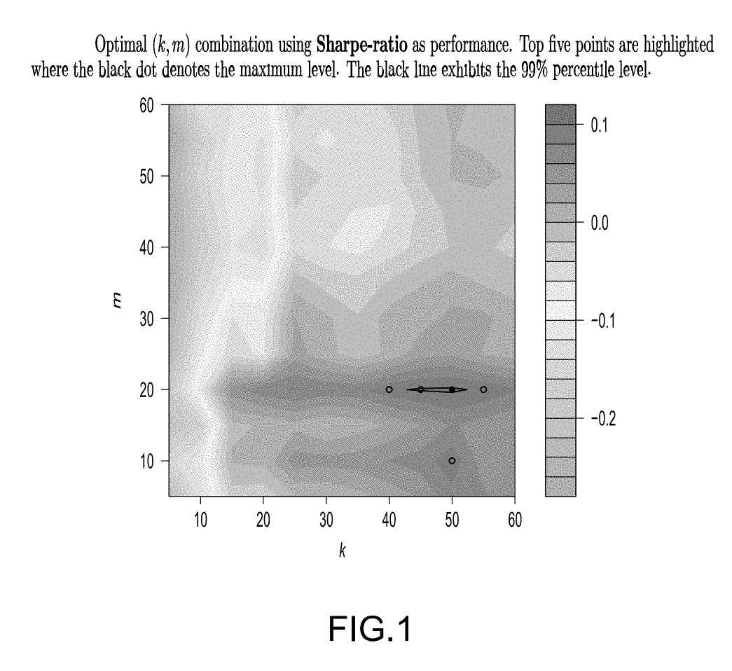

We find the optimal combination that maximizes the statistic from Equation (5) over the span of the data, i.e. t=1993, . . . , 2016. By considering SR as the performance measure and different values for k, m=5, . . . , 60 and, we summarize the Z statistic for each (k, m) combination in FIG. 1.

A couple of comments are in order. First, we observe that are multiple optimal points identified as the top 5 performing combos (black dot denotes the maximum level. The black line in the contour denotes the 99% level, i.e. there are only 1% combos that yield better performance than this.

Second, for a fixed m, we observe that the statistic is higher the lower the k is. On the other hand, for a small fixed k, higher levels are concentrated around larger values of m however we still observe a peak for low values of m.

Finally, the optimal (k, m) combo is the one associated with the maximum level from FIG. 1, which is

(k*m*)=(50,20) (7)

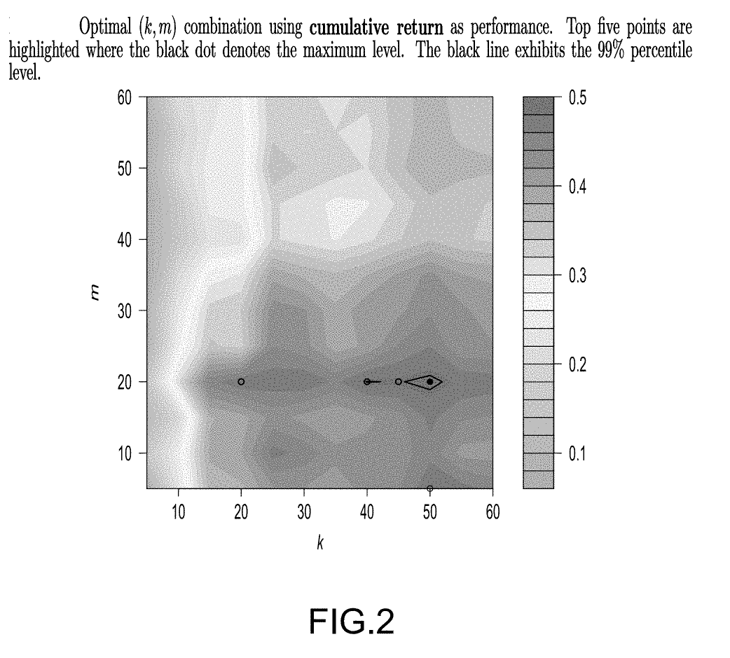

We repeat the same as above but with respect to annual cumulative return as the performance of interest. We find the following optimal combination, which is the maximum point (black dot) illustrated in FIG. 2:

(k*m*)=(50,20) (8)

### 2.3.2 Challenges

While the statistic in (5) takes into account the sensitivity of the benchmark outperformance, it appears that the strategy outperforms the benchmark 68% of the time, using SR as performance measure with k* and m*). Hence, 32% of the time the strategy underperformes the benchmark. A main problem arises with in-sample approach is that it does not take into account two main issues:

### 1. Sensitivity of k and m Over the Years

2. Confidence about Performance Out-of-Sample

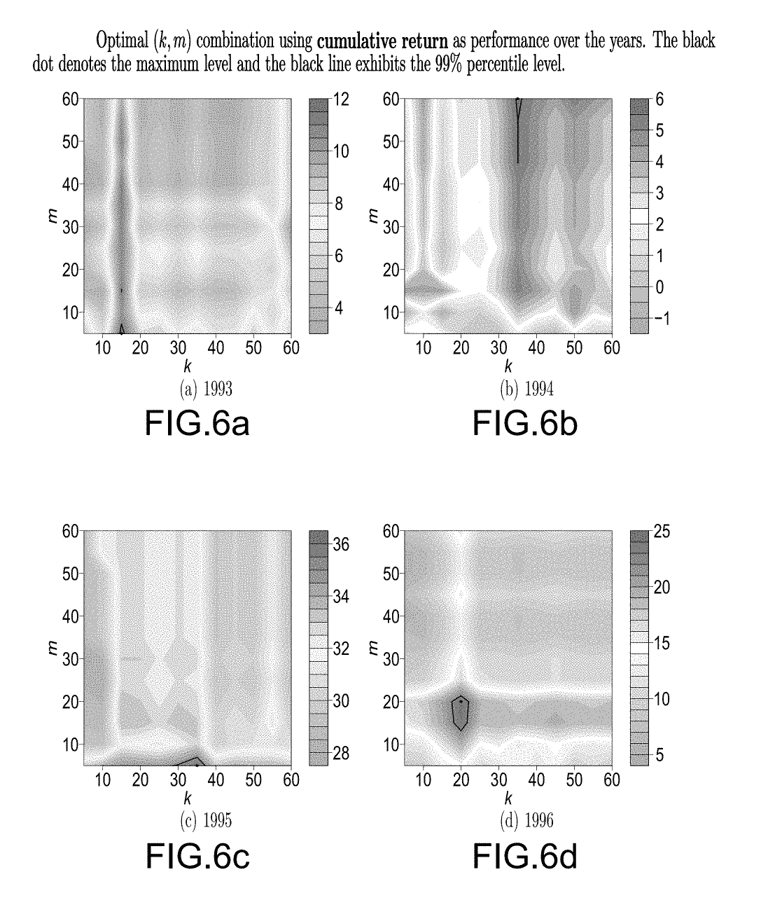

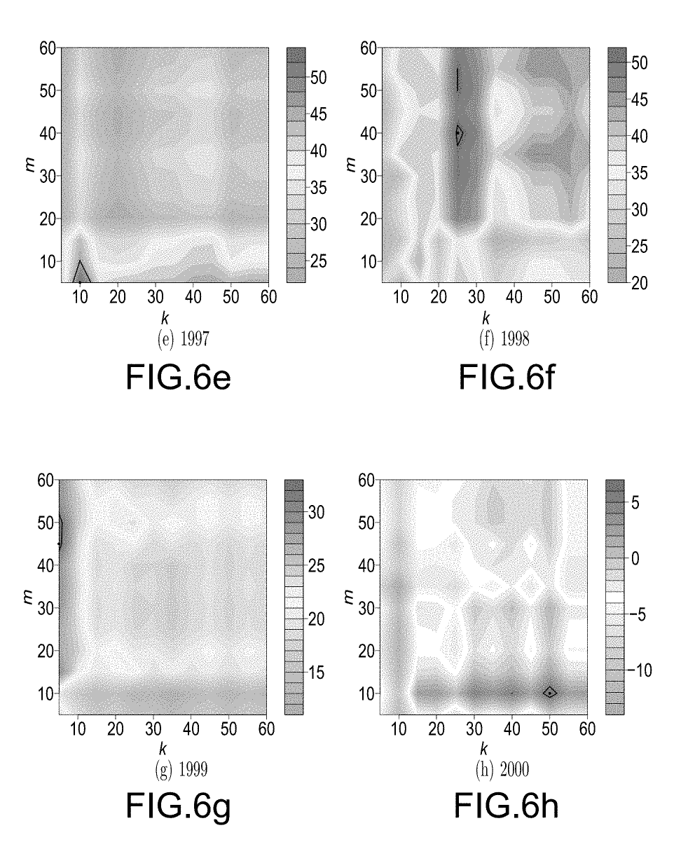

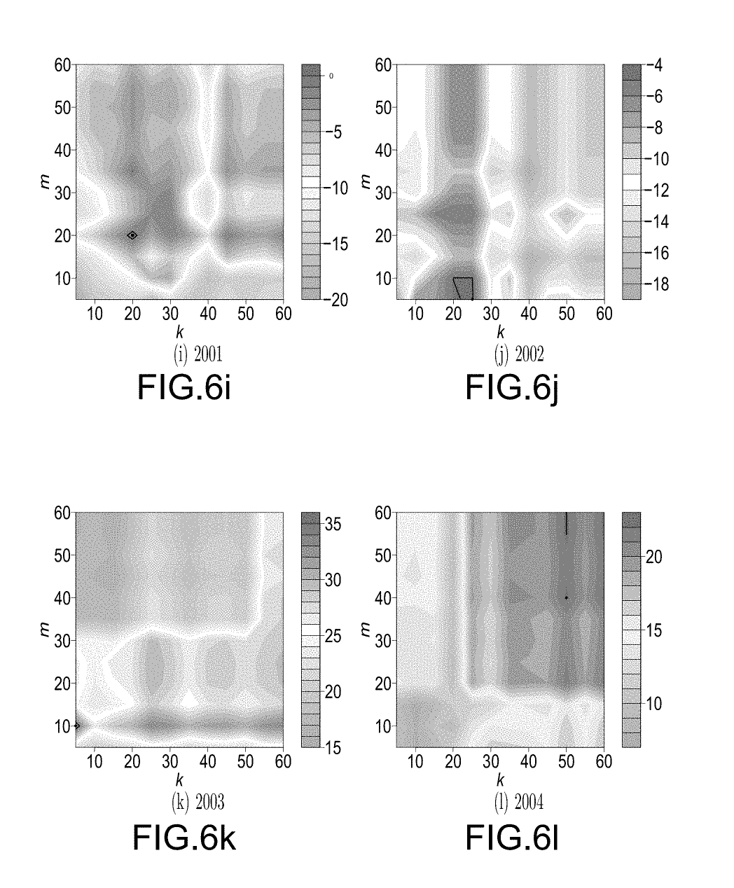

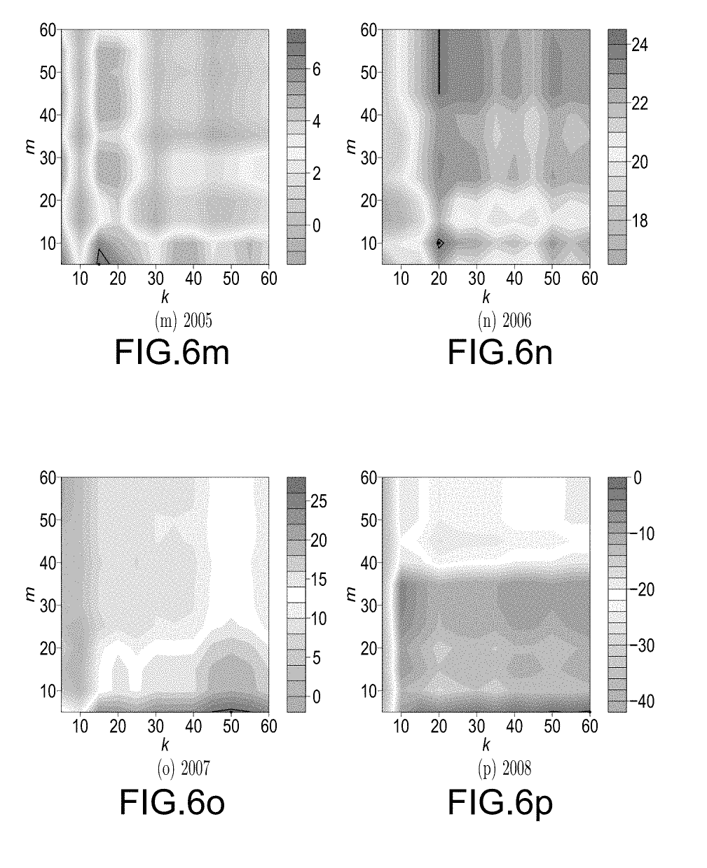

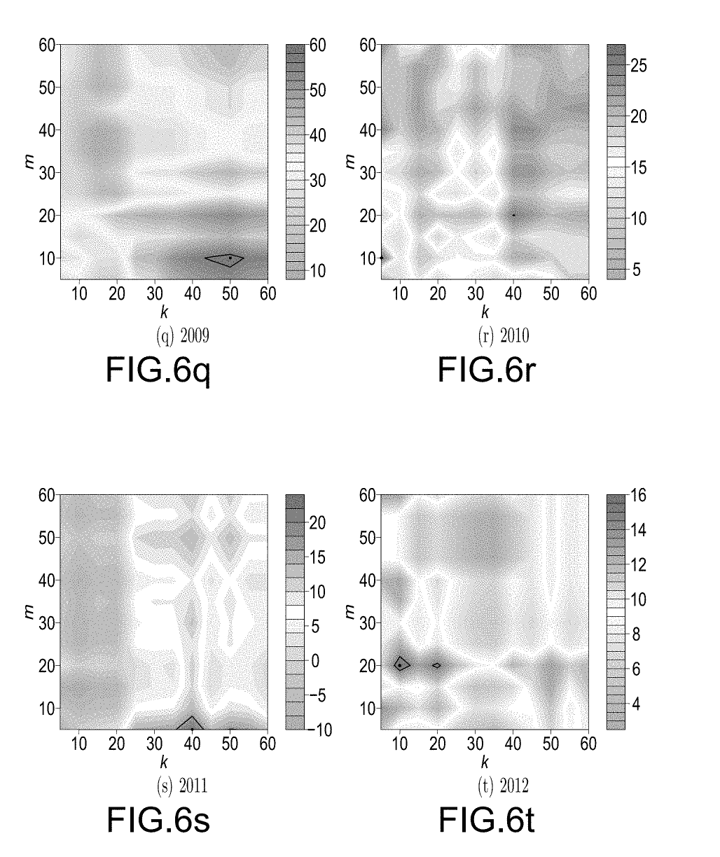

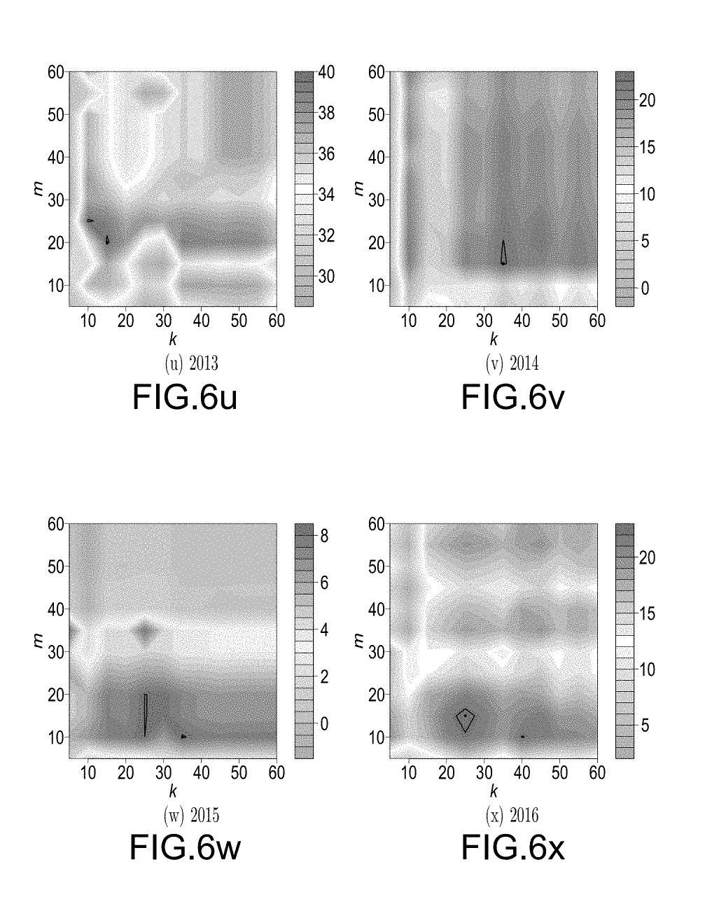

We demonstrate the sensitivity of k and m over the years in Table 5 and FIG. 6. As we can see there is a large heterogeneity over the years. This raises a flag regarding the robustness of the performance over the test of time. In order to address this we consider a rolling window, which we discuss below.

### 2.3.3 Rolling Window

Starting with Y=10 years of history (1993 and 2002 included), we find the optimal (k, m) combo in-sample and test the performance of the strategy over the next year. In the following year, we do the same exercise, where we find the new optimal combo using the more recent Y years and test the performance over the next year. We repeat this exercise until we reach the last year in the data.

Standing at the end of year y, we determine (k, m) for the next year, y+1, as follows

$$( {k}_{y + 1}^{*} , {m}_{y + 1}^{*} ) = {arg max}_{k , m} ( {Z}_{y} ( k , m ) ) . \qquad ( 9 )$$

We summarize the optimal values in Table 1 for Y=10 using either the SR or the cumulative return as the performance measure of interest.

TABLE 1
Optimal (k*ᵥ₊₁, m*_{y+1}) over years using
a rolling window of Y years of history.
Panel (a) SR as performance

| Year y + 1 | kᵥ₊₁ | m_{y+1} |
|---|---|---|
| 2003 | 15 | 15 |
| 2004 | 20 | 20 |
| 2005 | 25 | 20 |
| 2006 | 25 | 10 |
| 2007 | 25 | 25 |
| 2008 | 25 | 25 |
| 2009 | 50 | 20 |
| 2010 | 30 | 10 |
| 2011 | 60 | 20 |
| 2012 | 50 | 5 |
| 2013 | 50 | 5 |
| 2014 | 50 | 5 |
| 2015 | 50 | 5 |
| 2016 | 50 | 5 |

Panel (b) Cumulative return as performance

| Year y + 1 | kᵥ₊₁ | m_{y+1} |
|---|---|---|
| 2003 | 20 | 20 |
| 2004 | 20 | 20 |
| 2005 | 20 | 20 |
| 2006 | 20 | 20 |
| 2007 | 25 | 10 |
| 2008 | 25 | 10 |
| 2009 | 50 | 5 |
| 2010 | 50 | 5 |
| 2011 | 60 | 5 |
| 2012 | 25 | 5 |
| 2013 | 55 | 5 |
| 2014 | 50 | 5 |
| 2015 | 55 | 5 |
| 2016 | 55 | 5 |

### 3 Summary of Strategy Performance

### 3.1 Overall

In Table 2, we summarize the performance of the strategy over the whole sample with respect to the above benchmark as well as a reversal strategy that relies on S&P 500 alone.

TABLE 2
Summary of strategy out-of-sample performance using a rolling window approach
over the years between January 2003 and December 2016. Panels (a) and (b) summarize the
results, respectively, with regard to SR and cumulative return as performance
measures with optimal (k, m) chosen based on Panels (a) and (b) from Table 1

| | | | | | |
|---|---|---|---|---|---|
| VIX | SNP | VIX_SNP | BENCH- | | |
| SIGNAL | SIGNAL | SIGNAL | MARK | SPY | IEF |

Panel (a) SR as performance measure

| | | | | | | |
|---|---|---|---|---|---|---|
| Mean_Annual | 4.04 | 15.66 | 13.86 | 8.16 | 10.33 | 4.90 |
| Std_Annual | 14.32 | 14.14 | 17.37 | 10.49 | 18.73 | 6.82 |
| Cum_Ret | 32.97 | 689.94 | 470.26 | 192.24 | 234.90 | 93.11 |
| SR | 0.28 | 1.11 | 0.80 | 0.78 | 0.55 | 0.72 |
| MDD | −11.01 | −3.06 | −1.03 | −0.83 | −1.28 | −8.41 |
| No. Trades | 1808.00 | 1896.00 | 572.00 | | | |
| Prop. IEF Held | 0.48 | 0.50 | 0.14 | | | |
| SPY Cum_Ret | 29.10 | 555.96 | 453.01 | | | |
| IEF Cum_Ret | 23.87 | 133.97 | 17.25 | | | |

Panel (b) Cumulative return as performance measure

| | | | | | | |
|---|---|---|---|---|---|---|
| Mean_Annual | 2.25 | 16.36 | 14.65 | 8.16 | 10.33 | 4.90 |
| Std_Annual | 14.03 | 14.15 | 17.27 | 10.49 | 18.73 | 6.82 |
| Cum_Ret | 19.58 | 771.62 | 539.08 | 192.24 | 234.90 | 93.11 |
| SR | 0.16 | 1.16 | 0.85 | 0.78 | 0.55 | 0.72 |
| MDD | −55.01 | −2.66 | −1.03 | −0.83 | −1.28 | −8.41 |
| No. Trades | 1842.00 | 1898.00 | 598.00 | | | |
| Prop. IEF Held | 0.48 | 0.50 | 0.15 | | | |
| SPY Cum_Ret | 0.50 | 627.26 | 513.05 | | | |
| IEF Cum_Ret | 19.08 | 144.35 | 26.03 | | | |

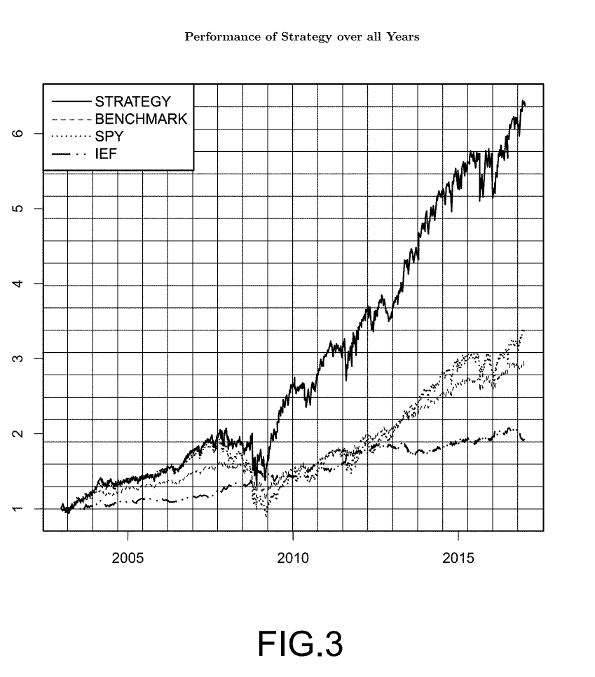

As we move on with this report, we will focus on the strategy extracted with respect to the cumulative return rather than the Sharpe-ratio, i.e. the one summarized in Panel (b) rather than Panel (a) in Table 2. To illustrate the performance of the strategy over the years, we plot the accumulated return of a single $1 invested in our strategy at the beginning of January 2003 and held until the end of December 2016. As comparison, we add the corresponding performance measure for the benchmark, the SPY, and the IEF. FIG. 3 demonstrates this.

### 3.2 Year Specific

For year specific performance, we focus on the cumulative return as the performance measure of interest. Similar to the presentation from Tables 4 and 2, we summarize the results for each year in Table 3.

TABLE 3
Summary of strategy performance over each year

| | | | | VIX | SNP | VIX SNP | BENCH- | | |
|---|---|---|---|---|---|---|---|---|---|
| Year | k | m | Statistic | SIGNAL | SIGNAL | SIGNAL | MARK | SPY | IEF |
| 2003 | 20 | 20 | Mean_Annual | 0.62 | 31.74 | 24.89 | 17.76 | 25.99 | 5.42 |
| 2003 | 20 | 20 | Std_Annual | 14.15 | 13.17 | 16.19 | 9.32 | 16.46 | 7.59 |
| 2003 | 20 | 20 | Cum_Ret | −0.38 | 36.49 | 26.82 | 19.08 | 28.18 | 5.31 |
| 2003 | 20 | 20 | SR | 0.04 | 2.41 | 1.54 | 1.91 | 1.58 | 0.71 |
| 2003 | 20 | 20 | MDD | −12.08 | −0.11 | −0.68 | −0.03 | −0.10 | −7.43 |
| 2003 | 20 | 20 | No. Trades | 133.00 | 146.00 | 46.00 | | | |
| 2003 | 20 | 20 | Prop. IEF Held | 0.47 | 0.48 | 0.14 | | | |
| 2003 | 20 | 20 | SPY Cum_Ret | −8.62 | 35.09 | 27.64 | | | |
| 2003 | 20 | 20 | IEF Cum_Ret | 8.24 | 1.40 | −0.82 | | | |
| 2004 | 20 | 20 | Mean_Annual | 17.07 | 4.83 | 9.92 | 8.10 | 10.70 | 4.21 |
| 2004 | 20 | 20 | Std_Annual | 9.18 | 9.22 | 10.69 | 7.03 | 11.10 | 6.43 |
| 2004 | 20 | 20 | Cum_Ret | 18.27 | 4.55 | 9.88 | 8.24 | 10.70 | 4.12 |
| 2004 | 20 | 20 | SR | 1.86 | 0.52 | 0.93 | 1.15 | 0.96 | 0.66 |
| 2004 | 20 | 20 | MDD | −0.26 | −13.37 | −8.58 | −0.79 | −0.40 | −2.57 |
| 2004 | 20 | 20 | No. Trades | 118.00 | 132.00 | 42.00 | | | |
| 2004 | 20 | 20 | Prop. IEF Held | 0.45 | 0.51 | 0.17 | | | |
| 2004 | 20 | 20 | SPY Cum_Ret | 13.01 | 2.68 | 9.40 | | | |
| 2004 | 20 | 20 | IEF Cum_Ret | 5.26 | 1.87 | 0.48 | | | |
| 2005 | 20 | 20 | Mean_Annual | −0.93 | 8.48 | 4.54 | 4.21 | 5.20 | 2.71 |
| 2005 | 20 | 20 | Std_Annual | 7.89 | 8.50 | 9.87 | 6.44 | 10.28 | 5.00 |
| 2005 | 20 | 20 | Cum_Ret | −1.24 | 8.53 | 4.18 | 4.11 | 4.83 | 2.64 |
| 2005 | 20 | 20 | SR | −0.12 | 1.00 | 0.46 | 0.65 | 0.51 | 0.54 |
| 2005 | 20 | 20 | MDD | −8.27 | −7.79 | −0.99 | −0.94 | −2.07 | −3.97 |
| 2005 | 20 | 20 | No. Trades | 130.00 | 136.00 | 30.00 | | | |
| 2005 | 20 | 20 | Prop. IEF Held | 0.45 | 0.50 | 0.12 | | | |
| 2005 | 20 | 20 | SPY Cum_Ret | −3.66 | 8.02 | 3.61 | | | |
| 2005 | 20 | 20 | IEF Cum_Ret | 2.42 | 0.51 | 0.36 | | | |
| 2006 | 20 | 20 | Mean_Annual | 8.29 | 16.06 | 20.81 | 10.11 | 15.15 | 2.56 |
| 2006 | 20 | 20 | Std_Annual | 7.96 | 7.79 | 9.68 | 6.35 | 9.97 | 4.20 |
| 2006 | 20 | 20 | Cum_Ret | 8.34 | 17.13 | 22.66 | 10.46 | 15.85 | 2.52 |
| 2006 | 20 | 20 | SR | 1.04 | 2.06 | 2.15 | 1.59 | 1.52 | 0.61 |
| 2006 | 20 | 20 | MDD | −0.90 | −1.32 | −0.62 | −0.71 | −0.62 | −1.50 |
| 2006 | 20 | 20 | No. Trades | 136.00 | 140.00 | 54.00 | | | |
| 2006 | 20 | 20 | Prop. IEF Held | 0.48 | 0.50 | 0.16 | | | |
| 2006 | 20 | 20 | SPY Cum_Ret | 7.74 | 11.38 | 19.90 | | | |
| 2006 | 20 | 20 | IEF Cum_Ret | 0.60 | 5.75 | 2.76 | | | |
| 2007 | 25 | 10 | Mean_Annual | −9.86 | 29.43 | 13.96 | 7.76 | 6.25 | 10.01 |
| 2007 | 25 | 10 | Std_Annual | 11.99 | 11.93 | 15.39 | 8.53 | 15.84 | 5.94 |
| 2007 | 25 | 10 | Cum_Ret | −10.08 | 33.40 | 13.61 | 7.70 | 5.15 | 10.38 |
| 2007 | 25 | 10 | SR | −0.82 | 2.47 | 0.90 | 0.91 | 0.39 | 1.69 |
| 2007 | 25 | 10 | MDD | −23.03 | −4.15 | −2.70 | −2.73 | −9.92 | −2.44 |
| 2007 | 25 | 10 | No. Trades | 138.00 | 140.00 | 42.00 | | | |
| 2007 | 25 | 10 | Prop. IEF Held | 0.47 | 0.53 | 0.12 | | | |
| 2007 | 25 | 10 | SPY Cum_Ret | −9.17 | 23.87 | 12.58 | | | |
| 2007 | 25 | 10 | IEF Cum_Ret | −0.90 | 9.53 | 1.03 | | | |
| 2008 | 25 | 10 | Mean_Annual | −45.00 | 19.64 | −10.07 | −15.44 | −36.92 | 16.77 |
| 2008 | 25 | 10 | Std_Annual | 28.76 | 28.52 | 34.72 | 23.10 | 41.13 | 9.76 |
| 2008 | 25 | 10 | Cum_Ret | −39.20 | 17.11 | −15.00 | −16.73 | −36.80 | 17.92 |
| 2008 | 25 | 10 | SR | −1.56 | 0.69 | −0.29 | −0.67 | −0.90 | 1.72 |
| 2008 | 25 | 10 | MDD | −46.87 | −1.10 | −36.34 | −27.95 | −47.12 | −1.10 |
| 2008 | 25 | 10 | No. Trades | 145.00 | 137.00 | 24.00 | | | |
| 2008 | 25 | 10 | Prop. IEF Held | 0.45 | 0.52 | 0.08 | | | |
| 2008 | 25 | 10 | SPY Cum_Ret | −40.81 | −0.62 | −21.89 | | | |
| 2008 | 25 | 10 | IEF Cum_Ret | 1.62 | 17.73 | 6.90 | | | |
| 2009 | 50 | 5 | Mean_Annual | 18.40 | 21.42 | 45.13 | 13.50 | 26.72 | −6.33 |
| 2009 | 50 | 5 | Std_Annual | 19.73 | 20.55 | 24.81 | 15.18 | 26.53 | 9.42 |
| 2009 | 50 | 5 | Cum_Ret | 18.03 | 21.51 | 52.76 | 13.26 | 26.35 | −6.59 |
| 2009 | 50 | 5 | SR | 0.93 | 1.04 | 1.82 | 0.89 | 1.01 | −0.67 |
| 2009 | 50 | 5 | MDD | −8.95 | −3.81 | −1.36 | −1.23 | −1.14 | −9.69 |
| 2009 | 50 | 5 | No. Trades | 128.00 | 139.00 | 50.00 | | | |
| 2009 | 50 | 5 | Prop. IEF Held | 0.46 | 0.53 | 0.16 | | | |
| 2009 | 50 | 5 | SPY Cum_Ret | 16.38 | 23.85 | 49.60 | | | |
| 2009 | 50 | 5 | IEF Cum_Ret | 1.66 | −2.35 | 3.16 | | | |
| 2010 | 50 | 5 | Mean_Annual | 0.45 | 20.49 | 15.33 | 12.97 | 15.51 | 9.17 |
| 2010 | 50 | 5 | Std_Annual | 12.61 | 15.29 | 17.02 | 9.50 | 17.86 | 7.62 |
| 2010 | 50 | 5 | Cum_Ret | −0.34 | 21.49 | 15.02 | 13.45 | 15.06 | 9.36 |
| 2010 | 50 | 5 | SR | 0.04 | 1.34 | 0.90 | 1.37 | 0.87 | 1.20 |
| 2010 | 50 | 5 | MDD | −8.04 | −0.63 | −0.63 | −3.08 | −0.16 | −7.21 |
| 2010 | 50 | 5 | No. Trades | 131.00 | 130.00 | 46.00 | | | |
| 2010 | 50 | 5 | Prop. IEF Held | 0.50 | 0.48 | 0.18 | | | |
| 2010 | 50 | 5 | SPY Cum_Ret | 160.28 | 10.06 | 15.82 | | | |
| 2010 | 50 | 5 | IEF Cum_Ret | −160.62 | 11.43 | −0.80 | | | |
| 2011 | 60 | 5 | Mean_Annual | −4.96 | 11.28 | 14.00 | 8.60 | 4.49 | 14.76 |
| 2011 | 60 | 5 | Std_Annual | 17.89 | 16.26 | 22.08 | 11.78 | 22.93 | 8.17 |
| 2011 | 60 | 5 | Cum_Ret | −6.41 | 10.56 | 12.35 | 8.30 | 1.89 | 15.65 |
| 2011 | 60 | 5 | SR | −0.28 | 0.69 | 0.63 | 0.73 | 0.26 | 1.81 |
| 2011 | 60 | 5 | MDD | −22.40 | −10.33 | −1.66 | −0.15 | −18.61 | −1.51 |
| 2011 | 60 | 5 | No. Trades | 126.00 | 125.00 | 40.00 | | | |
| 2011 | 60 | 5 | Prop. IEF Held | 0.48 | 0.51 | 0.15 | | | |
| 2011 | 60 | 5 | SPY Cum_Ret | −7.78 | 1.71 | 7.22 | | | |
| 2011 | 60 | 5 | IEF Cum_Ret | 1.37 | 8.85 | 5.13 | | | |
| 2012 | 25 | 5 | Mean_Annual | 17.30 | 5.12 | 6.67 | 10.88 | 15.64 | 3.75 |
| 2012 | 25 | 5 | Std_Annual | 9.98 | 10.33 | 11.96 | 6.56 | 12.69 | 5.53 |
| 2012 | 25 | 5 | Cum_Ret | 18.29 | 4.69 | 6.14 | 11.26 | 15.99 | 3.66 |
| 2012 | 25 | 5 | SR | 1.73 | 0.50 | 0.56 | 1.66 | 1.23 | 0.68 |
| 2012 | 25 | 5 | MDD | −5.54 | −8.00 | −8.76 | −3.96 | −7.35 | −2.84 |
| 2012 | 25 | 5 | No. Trades | 134.00 | 118.00 | 44.00 | | | |
| 2012 | 25 | 5 | Prop. IEF Held | 0.53 | 0.47 | 0.17 | | | |
| 2012 | 25 | 5 | SPY Cum_Ret | 16.28 | 3.22 | 10.07 | | | |
| 2012 | 25 | 5 | IEF Cum_Ret | 2.01 | 1.48 | −3.93 | | | |
| 2013 | 55 | 5 | Mean_Annual | 13.04 | 23.90 | 30.79 | 14.62 | 28.40 | −6.05 |
| 2013 | 55 | 5 | Std_Annual | 8.99 | 9.26 | 10.82 | 6.78 | 11.03 | 6.13 |
| 2013 | 55 | 5 | Cum_Ret | 13.88 | 26.68 | 35.56 | 15.60 | 32.31 | −6.09 |
| 2013 | 55 | 5 | SR | 1.45 | 2.60 | 2.84 | 2.15 | 2.57 | −0.99 |
| 2013 | 55 | 5 | MDD | −0.45 | −0.87 | −0.16 | −0.03 | −0.02 | −9.08 |
| 2013 | 55 | 5 | No. Trades | 131.00 | 141.00 | 56.00 | | | |
| 2013 | 55 | 5 | Prop. IEF Held | 0.52 | 0.52 | 0.19 | | | |
| 2013 | 55 | 5 | SPY Cum_Ret | 12.36 | 24.50 | 30.82 | | | |
| 2013 | 55 | 5 | IEF Cum_Ret | 1.22 | 2.18 | 4.75 | | | |
| 2014 | 50 | 5 | Mean_Annual | 10.63 | 8.25 | 11.10 | 11.39 | 13.16 | 8.73 |
| 2014 | 50 | 5 | Std_Annual | 8.44 | 9.08 | 11.00 | 6.07 | 11.20 | 4.92 |
| 2014 | 50 | 5 | Cum_Ret | 10.91 | 8.22 | 11.16 | 11.96 | 13.46 | 9.07 |
| 2014 | 50 | 5 | SR | 1.26 | 0.91 | 1.01 | 1.88 | 1.17 | 1.78 |
| 2014 | 50 | 5 | MDD | −4.01 | −1.87 | −4.85 | −0.83 | −1.52 | −1.71 |
| 2014 | 50 | 5 | No. Trades | 128.00 | 137.00 | 49.00 | | | |
| 2014 | 50 | 5 | Prop. IEF Held | 0.50 | 0.51 | 0.17 | | | |
| 2014 | 50 | 5 | SPY Cum_Ret | 4.38 | 4.96 | 10.66 | | | |
| 2014 | 50 | 5 | IEF Cum_Ret | 6.53 | 3.26 | 1.10 | | | |
| 2015 | 55 | 5 | Mean_Annual | 7.14 | 3.96 | 4.85 | 2.12 | 2.46 | 1.70 |
| 2015 | 55 | 5 | Std_Annual | 11.79 | 13.04 | 15.39 | 8.67 | 15.37 | 6.58 |
| 2015 | 55 | 5 | Cum_Ret | 6.71 | 3.19 | 3.78 | 1.77 | 1.23 | 1.51 |
| 2015 | 55 | 5 | SR | 0.61 | 0.30 | 0.32 | 0.24 | 0.16 | 0.26 |
| 2015 | 55 | 5 | MDD | −8.48 | −1.88 | −4.49 | −2.82 | −11.91 | −5.36 |
| 2015 | 55 | 5 | No. Trades | 138.00 | 132.00 | 24.00 | | | |
| 2015 | 55 | 5 | Prop. IEF Held | 0.49 | 0.46 | 0.07 | | | |
| 2015 | 55 | 5 | SPY Cum_Ret | 6.40 | 2.61 | 3.97 | | | |
| 2015 | 55 | 5 | IEF Cum_Ret | 0.31 | 0.58 | −0.19 | | | |
| 2016 | 55 | 5 | Mean_Annual | −0.37 | 24.46 | 13.31 | 7.75 | 12.16 | 1.14 |
| 2016 | 55 | 5 | Std_Annual | 10.29 | 9.59 | 12.47 | 7.36 | 13.22 | 5.39 |
| 2016 | 55 | 5 | Cum_Ret | −0.90 | 27.24 | 13.41 | 7.80 | 12.00 | 1.00 |
| 2016 | 55 | 5 | SR | −0.04 | 2.55 | 1.07 | 1.05 | 0.92 | 0.21 |
| 2016 | 55 | 5 | MDD | −2.23 | −2.66 | −1.03 | −0.83 | −1.28 | −8.41 |
| 2016 | 55 | 5 | No. Trades | 123.00 | 142.00 | 50.00 | | | |
| 2016 | 55 | 5 | Prop. IEF Held | 0.52 | 0.49 | 0.19 | | | |
| 2016 | 55 | 5 | SPY Cum_Ret | 0.98 | 23.01 | 11.94 | | | |
| 2016 | 55 | 5 | IEF Cum_Ret | −1.88 | 4.23 | 1.46 | | | |

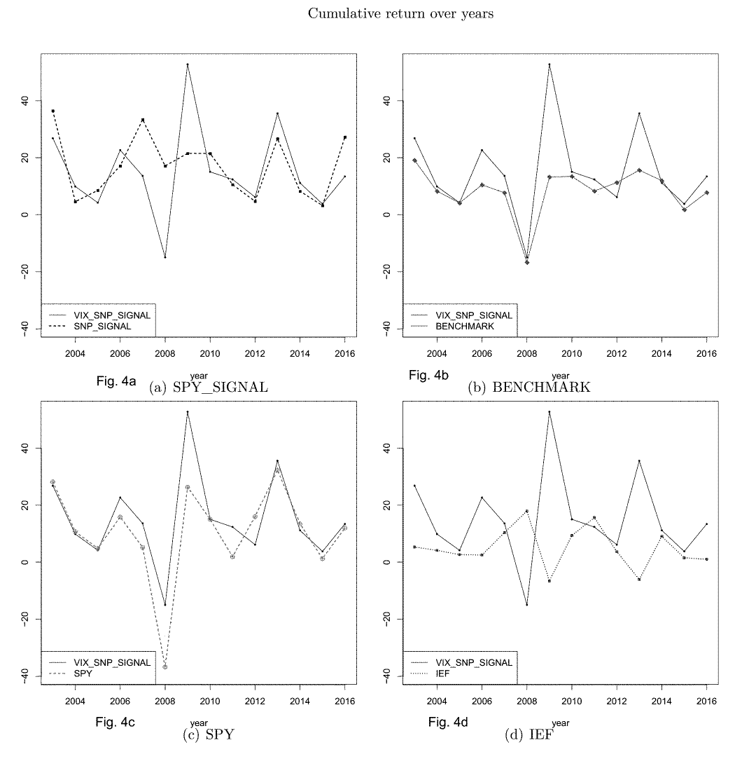

We also plot the cumulative return of the strategy over each year in order to determine whether total value is not driven by a single year. We compare the strategy with the S&P 500 mean reversion strategy as well as the benchmark. FIGS. 4a-4d illustrates this.

### 3.3 Buy-Sell Trigger

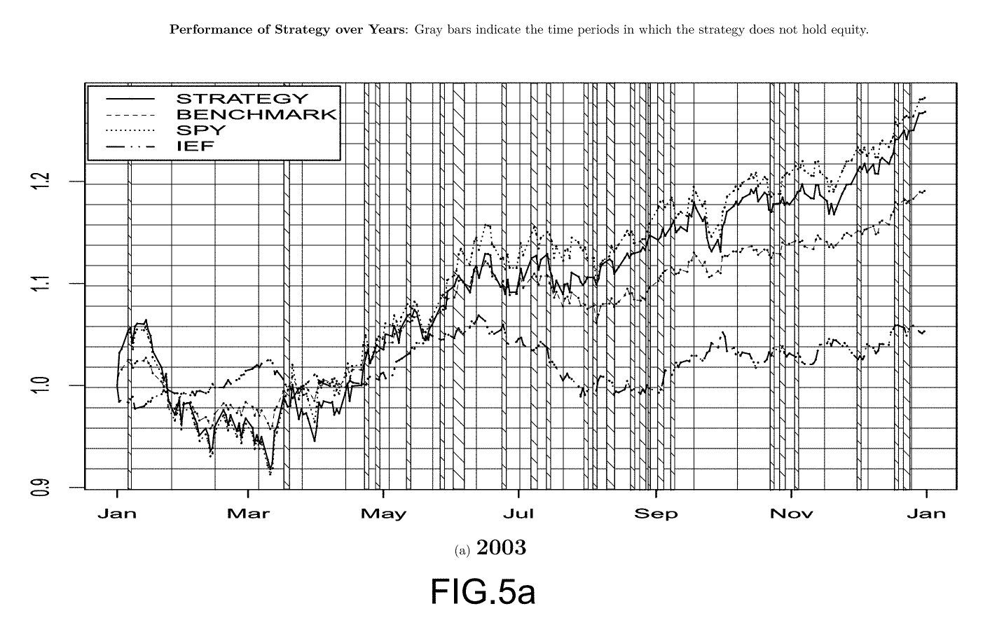

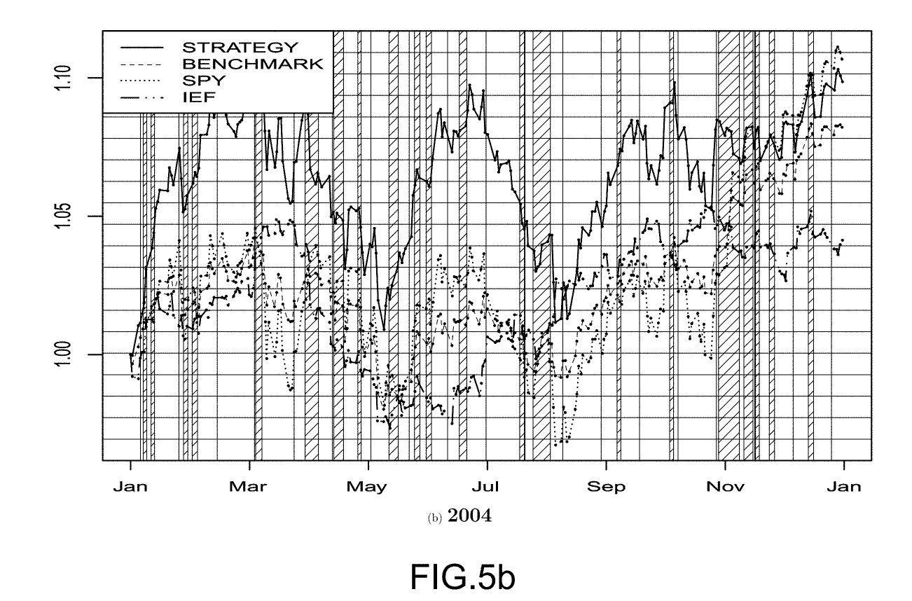

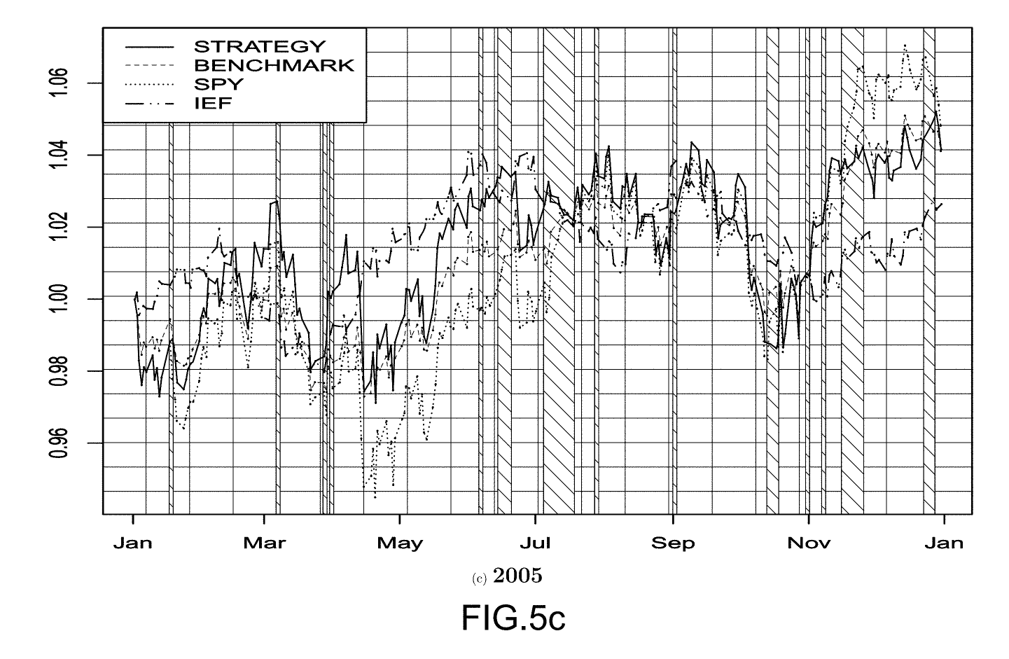

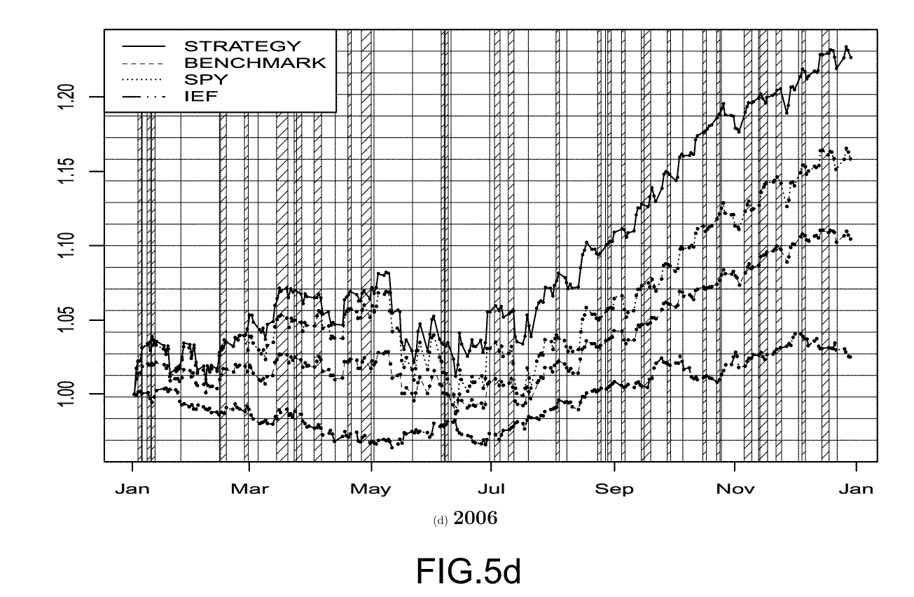

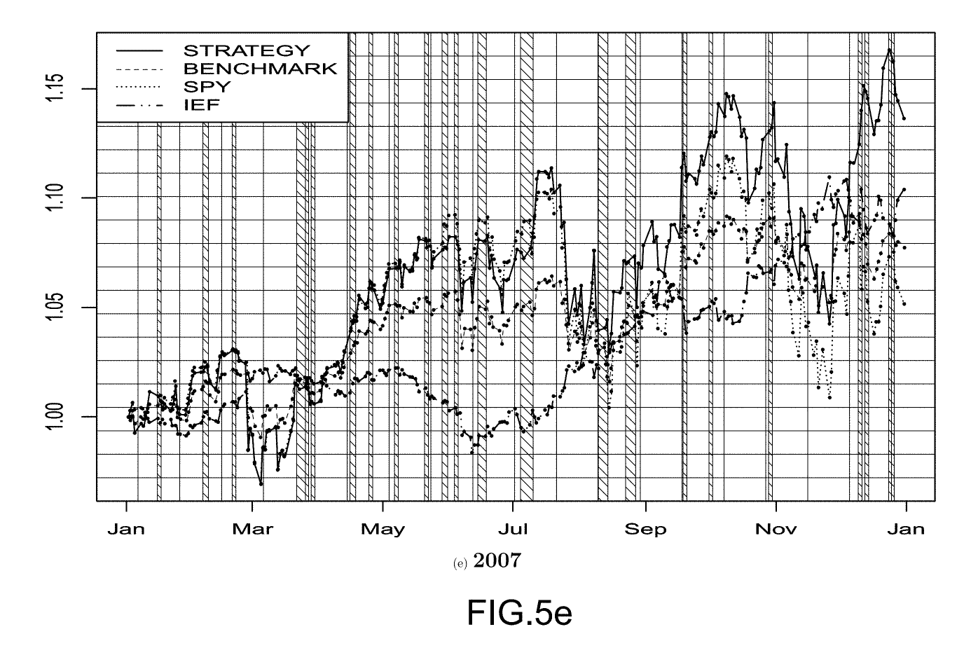

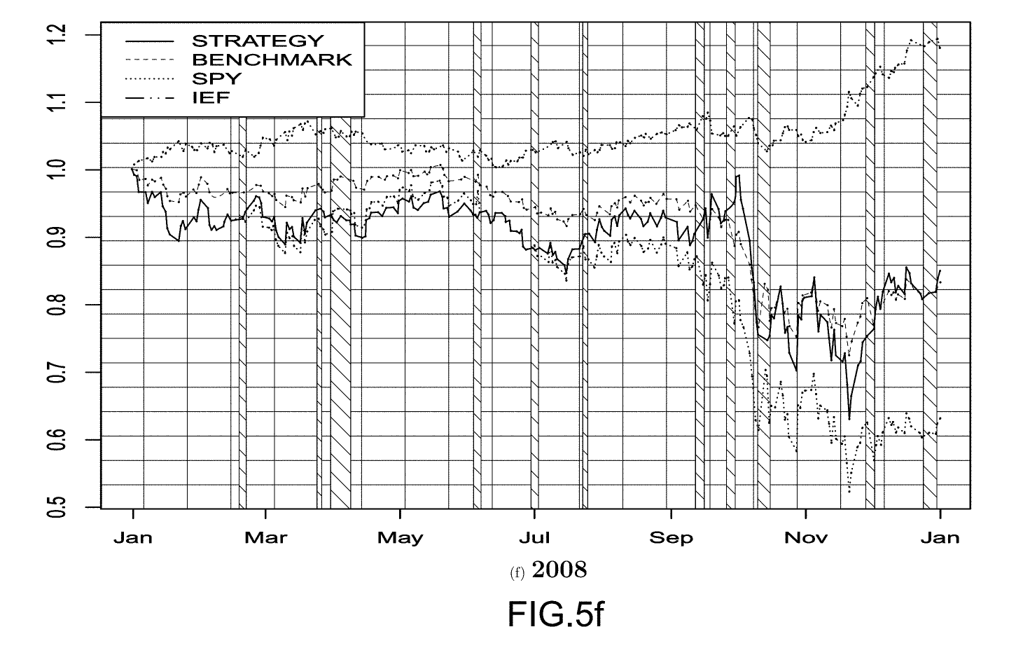

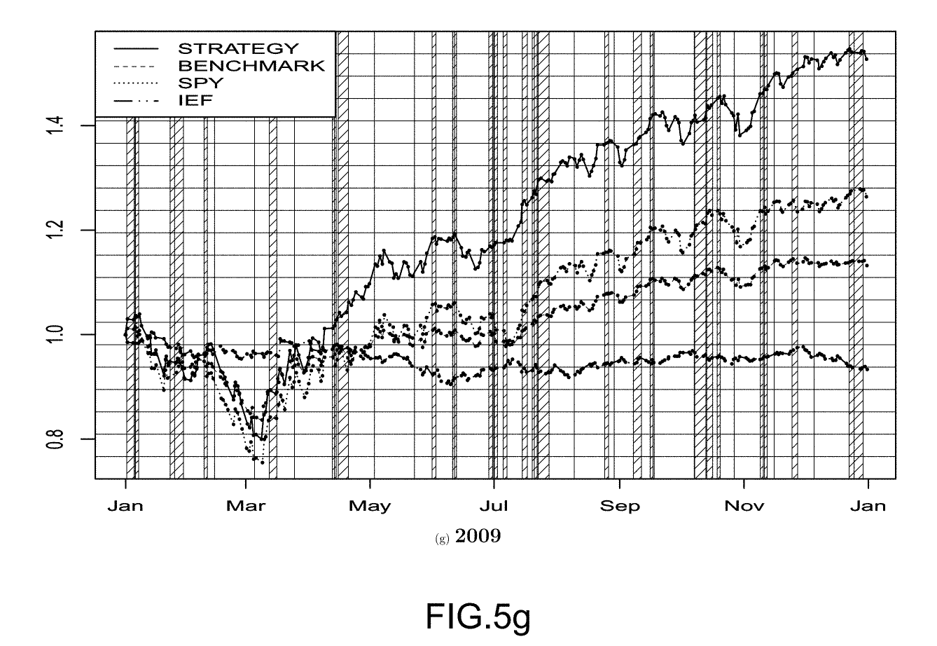

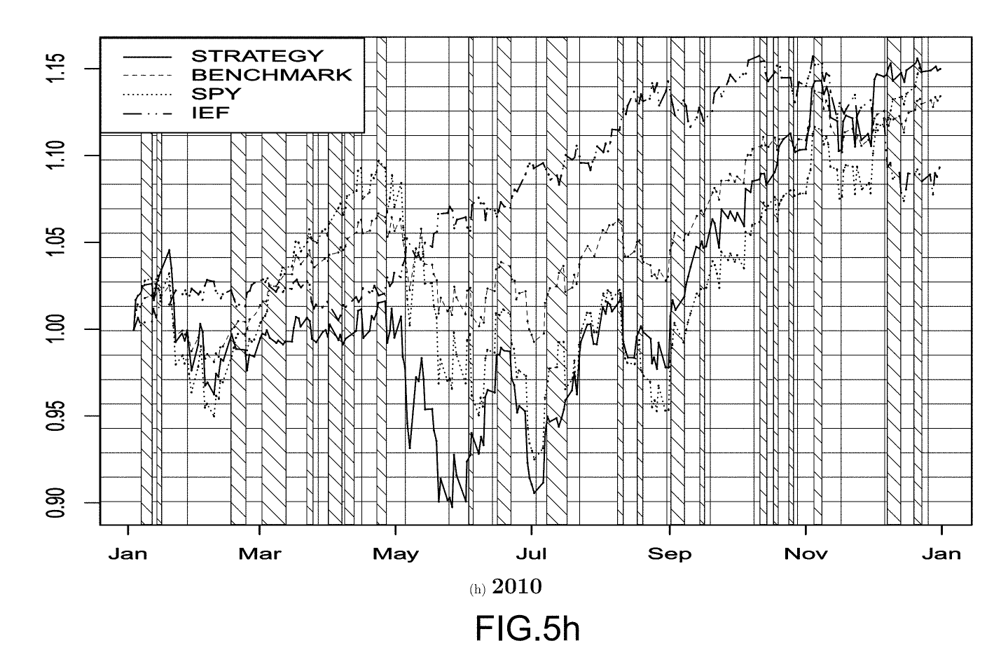

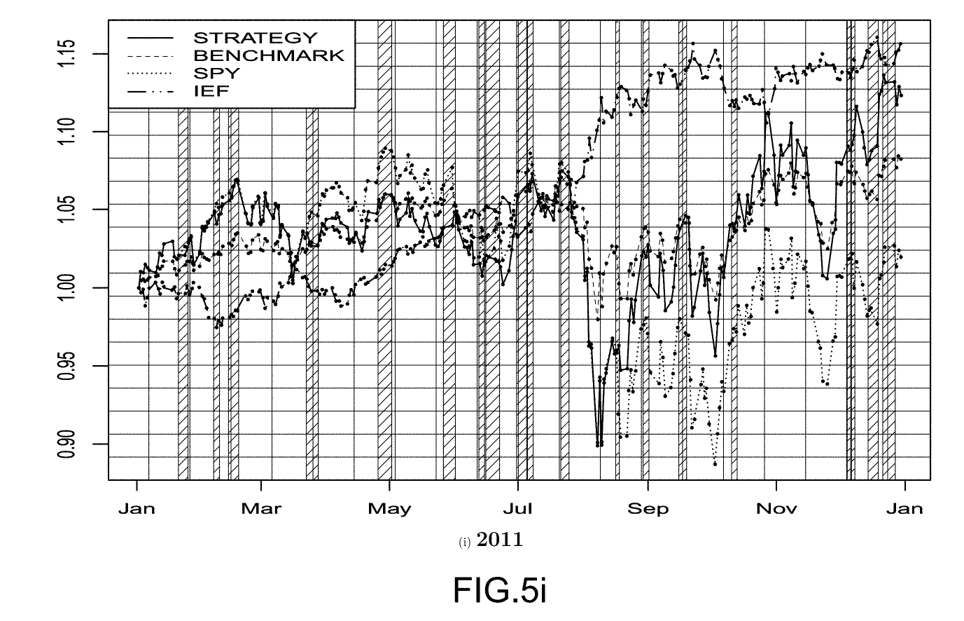

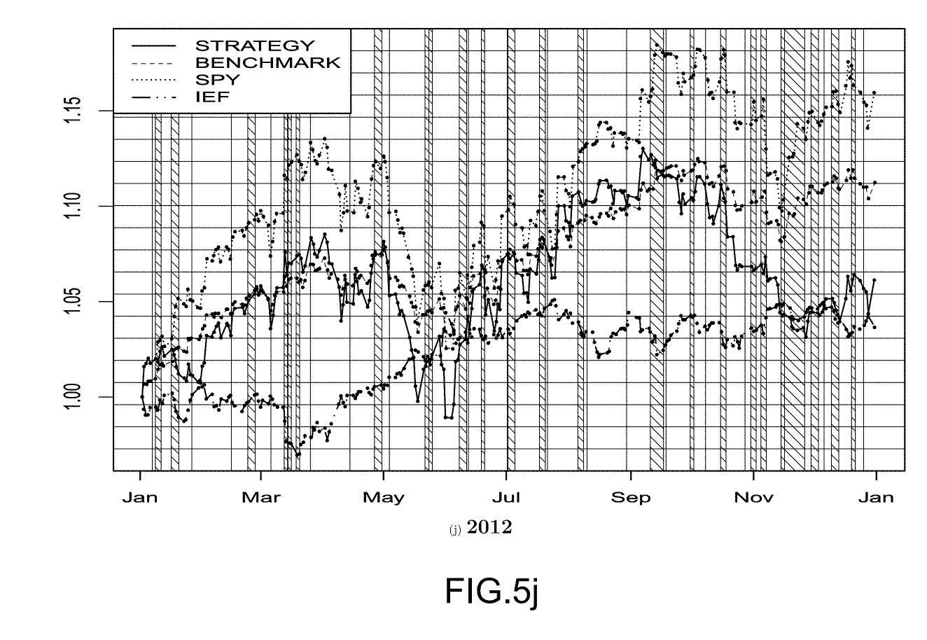

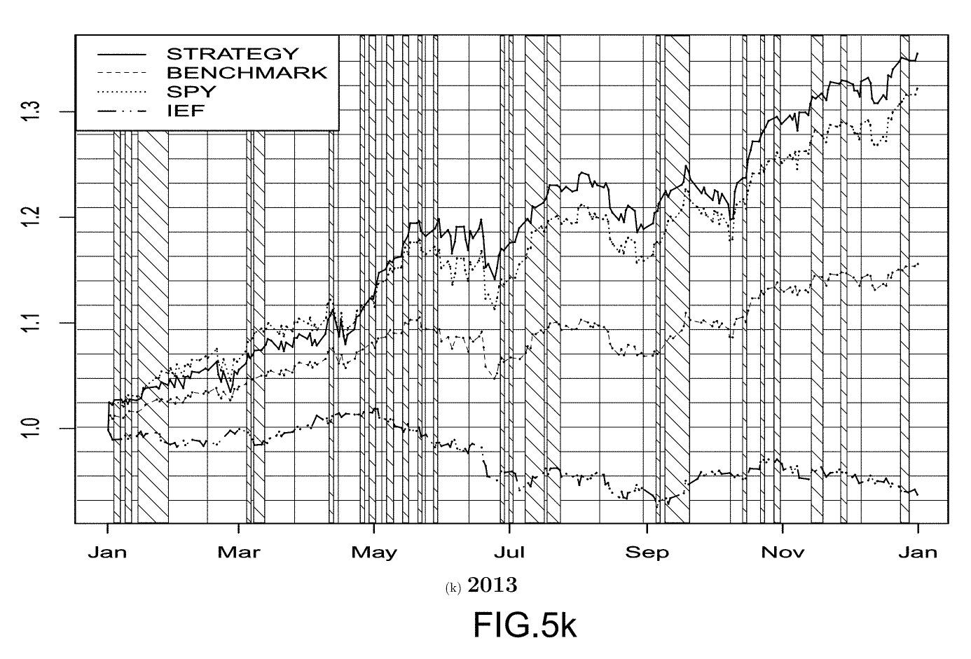

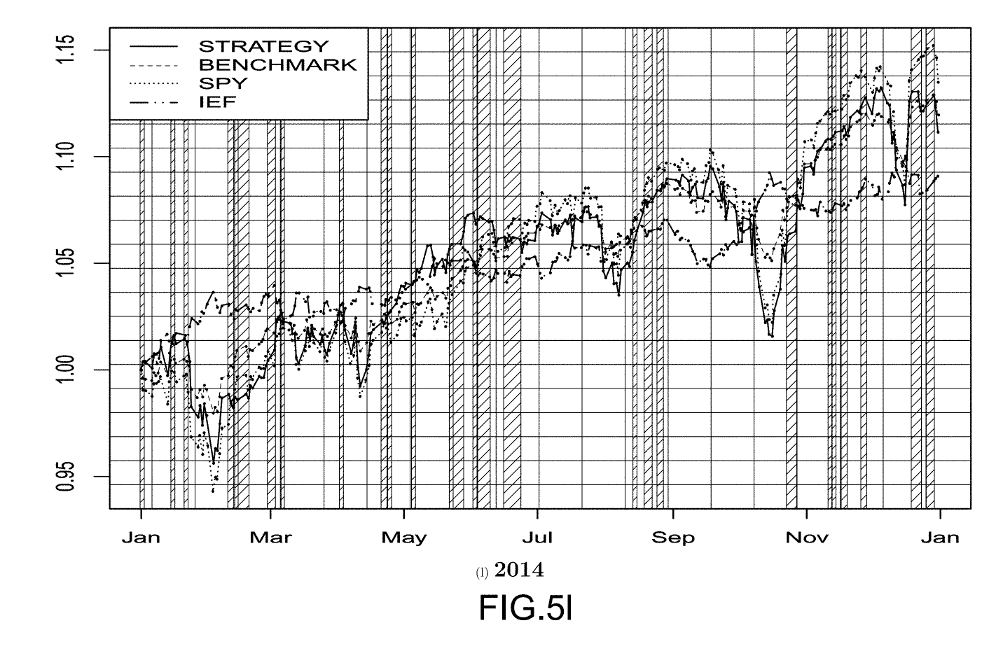

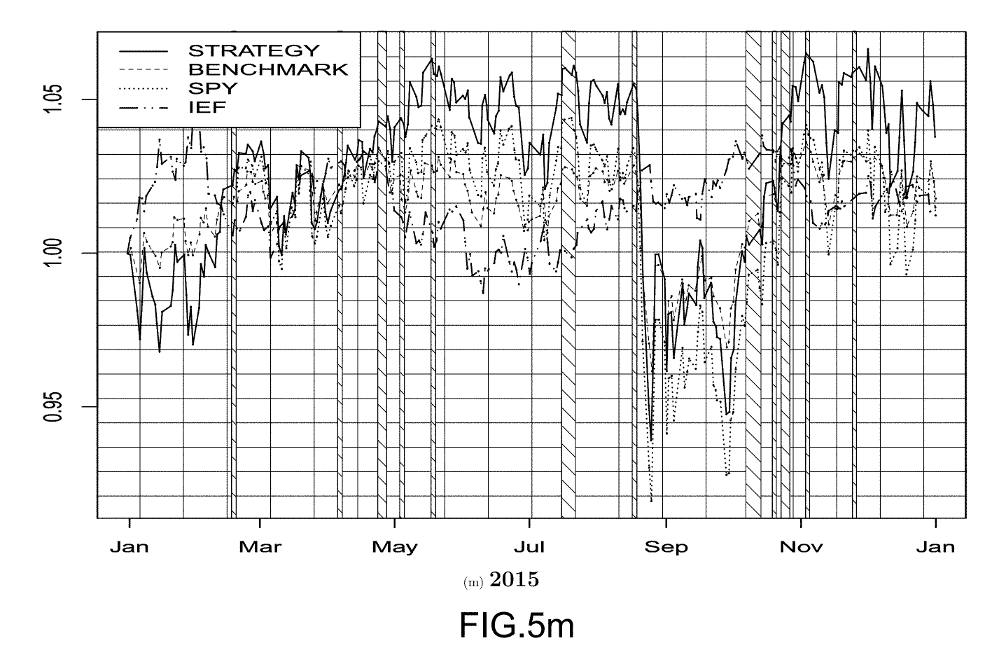

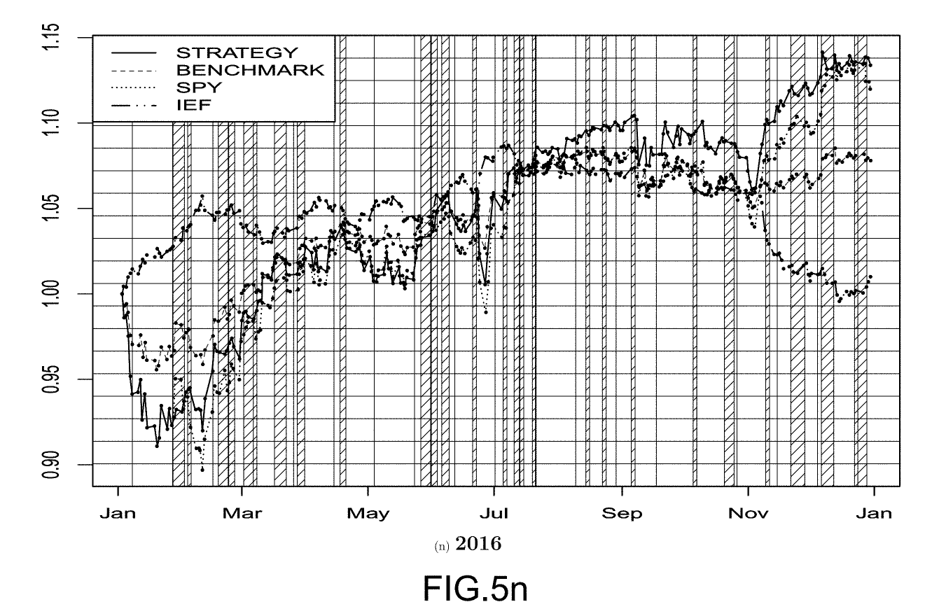

FIGS. 5a-5n demonstrate the sell-trigger periods, in which the strategy trades between the SPY and the IEF.

### In-Sample Results

The following table is similar to Table 2 in terms of format; however, the main difference is that the choice of the optimal k and m is determined in-sample. This is as a result raises the flag whether the results are due to over fitting and whether they stand the test of time. We consider these results only hypothetical and serve as an Utopian benchmark for our main results summarized in Table 2.

TABLE 4
Summary of strategy's in−sample performance over the years between
January 2003 and December 2010. Panels (a) and (b) summarize the results
for the optimal (k, m) combo from (??) and (??), respectively.

| | | | | | |
|---|---|---|---|---|---|
| VIX | SNP | VIX_SNP | | | |
| SIGNAL | SIGNAL | SIGNAL | BENCHMARK | SPY | IEF |

(k*, m*) = (50, 20)

| | | | | | | |
|---|---|---|---|---|---|---|
| Mean_Annual | 4.53 | 17.69 | 16.69 | 8.16 | 10.33 | 4.90 |
| Std_Annual | 14.34 | 15.08 | 17.99 | 10.49 | 18.73 | 6.82 |
| Cum_Ret | 63.69 | 930.97 | 737.07 | 192.24 | 234.90 | 93.11 |
| SR | 0.32 | 1.17 | 0.93 | 0.78 | 0.55 | 0.72 |
| MDD | −2.24 | −3.06 | −1.26 | −0.83 | −1.28 | −8.41 |
| No. Trades | 1779.00 | 1880.00 | 534.00 | | | |
| Prop. IEF Held | 0.46 | 0.50 | 0.13 | | | |
| SPY Cum_Ret | 41.90 | 764.29 | 701.85 | | | |
| IEF Cum_Ret | 21.73 | 166.68 | 35.22 | | | |

(k*, m*) = (50, 20)

| | | | | | | |
|---|---|---|---|---|---|---|
| Mean_Annual | 4.53 | 17.69 | 16.69 | 8.16 | 10.33 | 4.90 |
| Std_Annual | 14.34 | 15.08 | 17.99 | 10.49 | 18.73 | 6.82 |
| Cum_Ret | 63.69 | 930.97 | 737.07 | 192.24 | 234.90 | 93.11 |
| SR | 0.32 | 1.17 | 0.93 | 0.78 | 0.55 | 0.72 |
| MDD | −2.24 | −3.06 | −1.26 | −0.83 | −1.28 | −8.41 |
| No. Trades | 1779.00 | 1880.00 | 534.00 | | | |
| Prop. IEF Held | 0.46 | 0.50 | 0.13 | | | |
| SPY Cum_Ret | 41.96 | 764.29 | 701.85 | | | |
| IEF Cum_Ret | 21.73 | 166.68 | 35.22 | | | |

### Sensitivity

We look at the optimal combination (k, m) over the years to study the sensitivity of the strategy with respect to the chosen (k, m). We summarize the results in Table 5 using cumulative returns and Sharpe-ratio to proxy performance. Moreover, FIGS. 6a-6x demonstrate graphically the cumulative return over each year with respect to (k, m).

The message from Table 5 and FIGS. 6a-6x is that the strategy is sensitive to the choice of (k, m) over the years. What happens to be optimal in certain year does not necessarily imply optimality across different years. Hence, the choice of (k, m) should take into account the heterogeneity across the years that yields high performance with lower volatility (i.e. sensitivity).

TABLE 5
Optimal (k, m) combination over years

| Cumulative Returns | | | | Sharpe ratio | | | |
|---|---|---|---|---|---|---|---|
| Year | k | m | Cum_Ret | Year | k | m | SR |
| 1993 | 15.00 | 5.00 | 11.60 | 1993 | 15.00 | 5.00 | 1.44 |
| 1994 | 35.00 | 60.00 | 5.78 | 1994 | 35.00 | 60.00 | 0.63 |
| 1995 | 35.00 | 5.00 | 36.10 | 1995 | 35.00 | 5.00 | 3.88 |
| 1996 | 20.00 | 20.00 | 24.52 | 1996 | 20.00 | 20.00 | 1.82 |
| 1997 | 10.00 | 5.00 | 53.56 | 1997 | 10.00 | 5.00 | 2.36 |
| 1998 | 25.00 | 40.00 | 51.73 | 1998 | 25.00 | 40.00 | 2.07 |
| 1999 | 5.00 | 45.00 | 32.83 | 1999 | 5.00 | 45.00 | 1.77 |
| 2000 | 50.00 | 10.00 | 6.50 | 2000 | 50.00 | 10.00 | 0.39 |
| 2001 | 20.00 | 20.00 | 0.08 | 2001 | 20.00 | 20.00 | 0.10 |
| 2002 | 25.00 | 5.00 | −4.53 | 2002 | 25.00 | 5.00 | −0.07 |
| 2003 | 5.00 | 10.00 | 35.11 | 2003 | 5.00 | 10.00 | 1.99 |
| 2004 | 50.00 | 40.00 | 22.26 | 2004 | 50.00 | 40.00 | 1.90 |
| 2005 | 15.00 | 5.00 | 7.24 | 2005 | 15.00 | 5.00 | 0.75 |
| 2006 | 20.00 | 10.00 | 24.02 | 2006 | 20.00 | 10.00 | 2.29 |
| 2007 | 50.00 | 5.00 | 27.44 | 2007 | 50.00 | 5.00 | 1.69 |
| 2008 | 60.00 | 5.00 | −0.66 | 2008 | 60.00 | 5.00 | 0.17 |
| 2009 | 50.00 | 10.00 | 58.78 | 2009 | 50.00 | 10.00 | 2.00 |
| 2010 | 5.00 | 10.00 | 26.03 | 2010 | 5.00 | 10.00 | 1.46 |
| 2011 | 40.00 | 5.00 | 22.15 | 2011 | 40.00 | 5.00 | 1.02 |
| 2012 | 10.00 | 20.00 | 15.92 | 2012 | 10.00 | 20.00 | 1.30 |
| 2013 | 15.00 | 20.00 | 39.59 | 2013 | 10.00 | 25.00 | 3.13 |
| 2014 | 35.00 | 15.00 | 22.56 | 2014 | 35.00 | 15.00 | 1.90 |
| 2015 | 35.00 | 10.00 | 8.45 | 2015 | 35.00 | 10.00 | 0.61 |
| 2016 | 25.00 | 15.00 | 22.91 | 2016 | 25.00 | 15.00 | 1.68 |

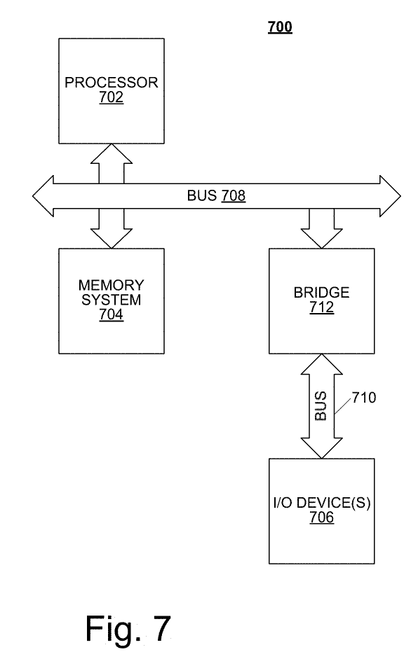

FIG. 7 is an example of a simplified functional block diagram of a computer system 700. The functional descriptions of the present invention can be implemented in hardware, software or some combination thereof. For example, a recommendation engine and an integration engine of the present invention can be implemented using a computer system.

As shown in FIG. 7, the computer system 700 includes a processor 702, a memory system 704 and one or more input/output (I/O) devices 706 in communication by a communication ‘fabric’. The communication fabric can be implemented in a variety of ways and may include one or more computer buses 708, 710 and/or bridge and/or router devices 712 as shown in FIG. 7. The I/O devices 706 can include network adapters and/or mass storage devices from which the computer system 700 can send and receive data for generating and transmitting advertisements with endorsements and associated news. The computer system 700 may be in communication with the Internet via the I/O devices 708.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

It is appreciated that the exemplary computing system is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A method for extracting signals from at least two major indices over time to develop a strategy, the method, with at least one computing device, comprising:
extracting at least one signal;
performing at least one action in response to the extracted at least one signal;
transmitting at least one notification comprising the at least one signal;
determining at least one optimal combination to calculate a sensitivity of the strategy; and
graphically representing a cumulative return over one or more years with respect to the at least one optimal combination;
wherein sensitivity is determined based on heterogeneity across the one or more years yielding high performance with lower volatility in relation to a moving average.

2-3. (canceled)

4. The method of claim 1, wherein the at least two major indices comprise the Standard & Poor's (S&P 500) and Volatility Index (VIX).

5. The method of claim 1, wherein the at least one signal is a buy signal.

6. The method of claim 1, wherein the at least one signal is a sell signal.

7. A system for extracting signals from at least two major indices to develop a strategy, the system comprising a processor and at least one memory comprising computer-executable instructions and coupled to the processor, the instructions when executed by the processor are configured to implement:
extracting at least one signal;
performing at least one action in response to the extracted at least one signal;
transmitting at least one notification comprising the at least one signal;
determining at least one optimal combination to calculate a sensitivity of the strategy; and
graphically representing a cumulative return over one or more years with respect to the at least one optimal combination;
wherein sensitivity is determined based on heterogeneity across the one or more years yielding high performance with lower volatility in relation to a moving average.

8-9. (canceled)

10. The system of claim 7, wherein the at least two major indices comprise the Standard & Poor's (S&P 500) and Volatility Index (VIX).

11. The system of claim 7, wherein the at least one signal is a buy signal.

12. The system of claim 7, wherein the at least one signal is a sell signal.

13. A non-transitory computer readable medium comprising instructions, the instructions when executed by a hardware processor implement a method for extracting signals from at least two major indices to develop a strategy, the method comprising:
extracting at least one signal;
performing at least one action in response to the extracted at least one signal;
transmitting at least one notification comprising the at least one signal;
determining at least one optimal combination to calculate a sensitivity of the strategy; and
graphically representing a cumulative return over one or more years with respect to the at least one optimal combination;
wherein sensitivity is determined based on heterogeneity across the one or more years yielding high performance with lower volatility in relation to a moving average.

14-15. (canceled)

16. The medium of claim 13, wherein the at least two major indices comprise the Standard & Poor's (S&P 500) and Volatility Index (VIX).

17. The medium of claim 13, wherein the at least one signal is a buy signal.

18. The medium of claim 13, wherein the at least one signal is a sell signal.
